(19) United States
(12) Patent Application Publication
(10) Pub. No.: US 2005/0269739 A1
(43) Pub. Date: Dec. 8, 2005

(54) Rubber pad fabrication method

(76) Inventor: Rong-Fen Chen, Taichung City (TW)

Correspondence Address: Rong-Feng Chen, P.O.BOX 2103, Taichung City, TW

(21) Appl. No.: 10/858,430

(22) Filed: Jun. 2, 2004

(51) Int. Cl. B29C 70/34

(52) U.S. Cl. 264/257

(57) ABSTRACT

A rubber pad fabrication method includes the steps of (a) putting in proper order a transparent rubber film, a piece of fabric having a design, and a dark color non-transparent rubber in the cavity of a first die and then closing a second die on the first die, (b) employing a pressure to the second die against the first die and simultaneously heating the first die and the second die to melt the transparent rubber film and the dark color non-transparent rubber, and (c) cooling down the first die and the second die and then removing the molded rubber pad from the cavity of the first die.

### BACKGROUND OF THE INVENTION

1. Field of the Invention

The present invention relates generally to a method of fabricating rubber pads for making outsoles for shoe or the like and more particularly, to such a rubber pad fabrication method, which is practical for making a rubber pad having a fabric ornament embedded on the inside.

2. Description of the Related Art

Rubber is intensively used for making outsoles for shoes, for example, sports shoes. An outsole for shoe has a three-dimensional design to attract consumers. FIGS. 6 and 7 show an outsole for shoe made according to the prior art. According to this design, the outsole comprises a transparent rubber base layer 50, a display layer 51 adhered to the top surface of the base layer 50, and a non-transparent rubber top layer 52 adhered to the top surface of the display layer 51. This design of outsole has numerous drawbacks. Because the transparent base layer forms the major part of the outsole, the cost of the outsole is high (transparency status of rubber material determines the cost). Further, the base layer has a surface design that curves outwards and inwards. This three-dimensional surface design deflects light in different directions, thereby causing people unable to view the right image of the design of the display layer. Further, because the display layer is sandwiched in between the transparent rubber base layer and the non-transparent rubber top layer, the display layer tends to be separated from the transparent rubber base layer and/or the non-transparent rubber top layer after a long use of the shoe.

### SUMMARY OF THE INVENTION

The present invention has been accomplished under the circumstances in view. It is the main object of the present invention to provide a rubber pad fabrication method, which is practical for making a rubber outsole that eliminates the aforesaid drawbacks. According to the present invention, the rubber pad fabrication method includes the steps of (a) putting in proper order a transparent rubber film, a piece of fabric having a design, and a dark color non-transparent rubber in the cavity of a first die and then closing a second die on the first die, (b) employing a pressure to the second die against the first die and simultaneously heating the first die and the second die to melt the transparent rubber film and the dark color non-transparent rubber, and (c) cooling down the first die and the second die and then removing the molded rubber pad from the cavity of the first die. Because the trans parent rubber film penetrates open spaces in the fabric when melted, the fabric is fixedly embedded in between the transparent rubber film and the dark color non-transparent rubber after molding of the rubber pad. Further, because the dark color non-transparent rubber forms the major part of the rubber pad, the cost of the rubber pad is low.

### BRIEF DESCRIPTION OF THE DRAWINGS

FIG. 1A is a schematic sectional view of a first die and a second die according to the present invention.

FIG. 1B is schematic sectional view showing putting order of materials in the cavity of the first die according to the present invention.

FIG. 1C is a schematic sectional view showing the second die closed on the first die.

FIG. 2 is a bottom view of an outsole for shoe made according to the present invention.

FIG. 3 is a sectional view taken along line 3-3 of FIG. 2.

FIG. 4 is a schematic drawing of alternate form of outsole for shoe made according to the present invention.

FIG. 5 is a sectional view taken along line 5-5 of FIG. 4.

FIG. 6 is an exploded view of an outsole for shoe made according to the prior art.

FIG. 7 is perspective view of a part of the outsole for shoe shown in FIG. 6.

### DETAILED DESCRIPTION OF THE INVENTION

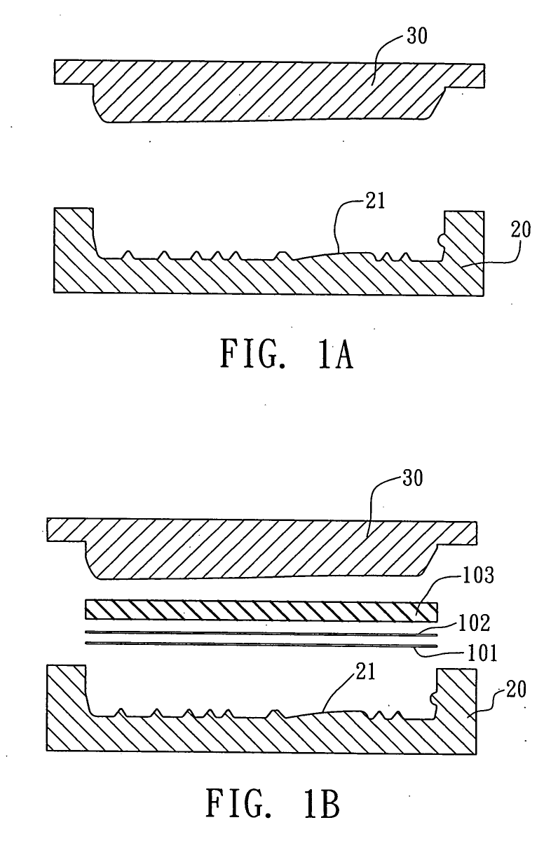

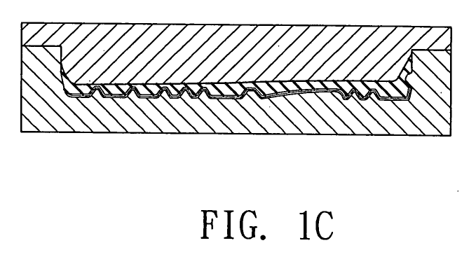

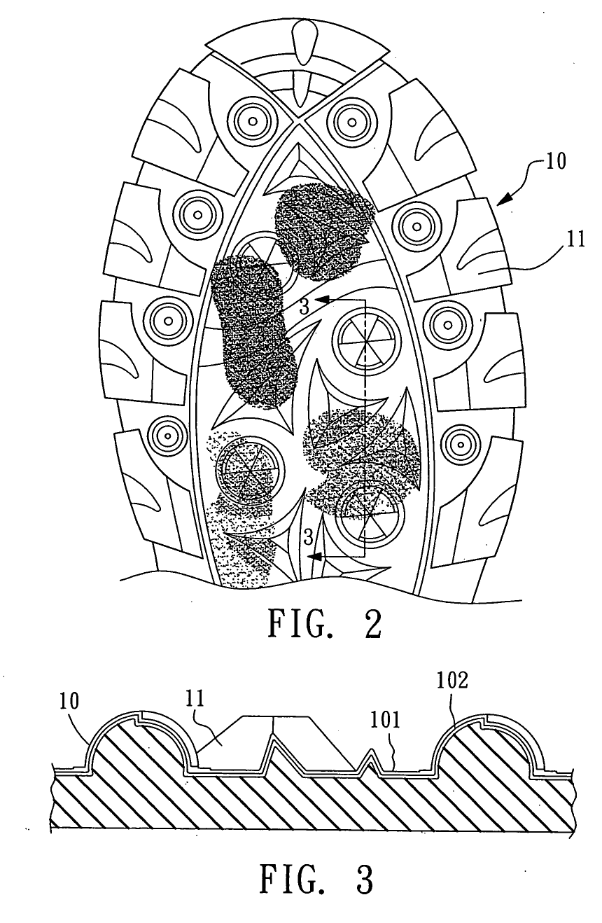

Referring to FIGS. 1-3, a rubber pad, for example, an outsole for shoe 10 in accordance with one embodiment of the present invention is shown having a three-dimensional surface design 11. The fabrication of the outsole for shoe 10 is outlined hereinafter.

At first, prepare a first (bottom) die 20, which has a cavity 21 made subject to the three-dimensional surface design 11 of the outsole for shoe 10 to be made. A transparent rubber film 101, a piece of fabric 102 and a non-transparent rubber 103 are put in the cavity 21 of the first (bottom) die 20 in proper order. The non-transparent rubber 103 has a dark color, for example, black color. The fabric 102 is set in the cavity 21 of the first (bottom) die 20 with the pattern thereof facing the transparent rubber film 101. Thereafter, a second (top) die 30 is closed on the first (bottom) die 20, and then employ a pressure to the second (top) die 30 against the first (bottom) die 20 and heat the first (bottom) die 20 and the second (top) die 30 to melt the transparent rubber film 101 and the non-transparent rubber 103, thereby causing the transparent rubber film 101 and the non-transparent rubber 103 to bond to each other with the fabric 102 embedded therein. Thereafter, cool down the first (bottom) die 20 and heat the first (bottom) die 20, and then remove the molded rubber pad from the cavity of the first (bottom) die 20. The non-transparent rubber 103 is much thicker than the transparent rubber film 101, and forms the base of the finished rubber pad 10. The transparent rubber film 101 forms the covering layer of the finished rubber pad 10.

According to the aforesaid embodiment, the invention has the following advantages:
1. The non-transparent rubber form the base of the outsole, the cost can be minimized.
2. The fabric can be made having any of a variety of designs by means of the employment of a printing or dying process.
3. The transparent rubber film penetrates open spaces in the fabric when melted, thereby enhancing the adhesion strength of the fabric to the base of the rubber pad.
4. This rubber pad fabrication method is practical for making a rubber pad on the surface of a rubber object.

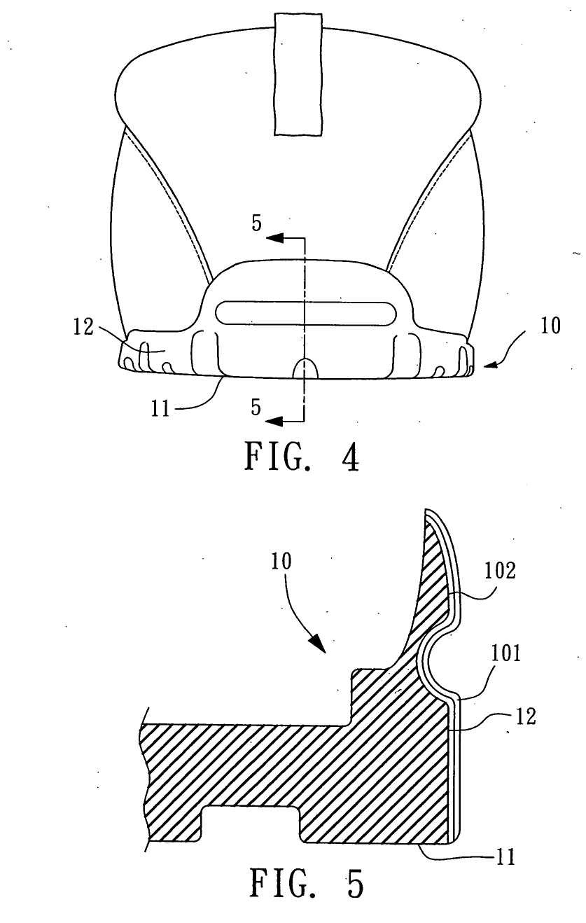

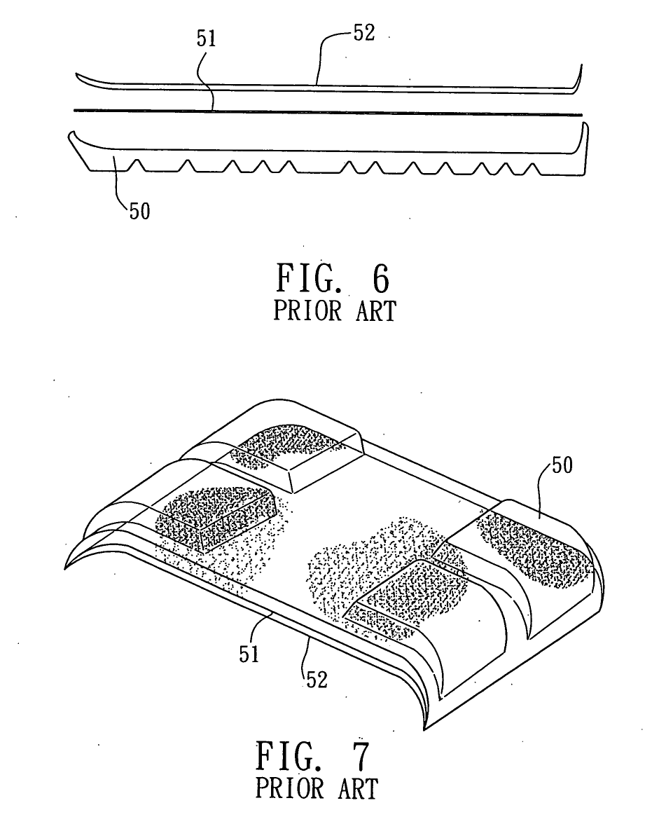

The fabric and the transparent rubber film (covering layer) may cover the whole area of the bottom side of the non-transparent rubber (base of the rubber pad). Alternatively, the fabric and the transparent rubber film can be situated at the periphery of the outsole as shown in FIG. 4 and FIG. 5, or the center area of the rubber pad as shown in FIG. 2.

According to an alternate form of the present invention, the rubber pad fabrication method comprises the steps of (a) putting a transparent rubber film and a piece of fabric having a pattern in the cavity of a first die, (b) closing a second die on the first die, (c) heating the first die and the second die to melt the transparent rubber film and simultaneously injecting a molten non-transparent rubber into the cavity of the first die, and (d) cooling down the first die and the second die, and then opening the second die from the first die, and then removing the molded rubber pad out of the cavity of the first die.

Although particular embodiments of the invention have been described in detail for purposes of illustration, various modifications and enhancements may be made without departing from the spirit and scope of the invention. Accordingly, the invention is not to be limited except as by the appended claims.

1. A rubber pad fabrication method comprising the steps of:
(a) preparing a first die and a second die, said first die having a cavity made subject to a predetermined three-dimensional surface design;
(b) putting a transparent rubber film, a piece of fabric having a design and a dark color non-transparent rubber in the cavity of said first die proper order, and then closing said second die on said first die;
(c) employing a pressure to said second die against said first die and simultaneously heating said first die and said second die to melt said transparent rubber film and said dark color non-transparent rubber;
(d) cooling down said first die and said second die, and then opening said second die from said first die, and then removing the molded rubber pad out of the cavity of said first die.

2. A rubber pad fabrication method comprising the steps of:
(a) preparing a first die having a cavity and a second, and then putting a transparent rubber film and a piece of fabric having a pattern in the cavity of said first die;
(b) closing said second die on said first die;
(c) heating said first die and said second die to melt said transparent rubber film and simultaneously injecting a molten non-transparent rubber into the cavity of said first die, and
(d) cooling down said first die and said second die, and then opening said second die from said first die, and then removing the molded rubber pad out of the cavity of said first die.
